(19) United States
(12) Patent Application Publication
(10) Pub. No.: US 2012/0296958 A1
(43) Pub. Date: Nov. 22, 2012

(54) INFORMATION PROCESSING APPARATUS, INFORMATION PROCESSING SYSTEM, INFORMATION PROCESSING METHOD, AND PROGRAM

(75) Inventor: Masaaki Isozu, Tokyo (JP)

(73) Assignee: Sony Corporation, Tokyo (JP)

(21) Appl. No.: 13/457,665

(22) Filed: Apr. 27, 2012

(30) Foreign Application Priority Data
May 17, 2011 (JP) 2011-109985

(51) Int. Cl. G06F 15/16

(52) U.S. Cl. 709/203; 709/217; 709/219

(57) ABSTRACT

Methods and apparatus for processing a request for image data. One exemplary embodiment is directed to an apparatus comprising at least one storage device configured to store a plurality of processor-executable instructions and at least one processing unit communicatively coupled to the at least one storage device. Upon execution of the processor-executable instructions, the processing unit receives from a client computer one or more requests for image data, generates at least one coupled-image file and a conversion layout file based, at least in part, on information in the one or more requests for image data, wherein the at least one coupled-image file includes image data for a plurality of images to form a combined image and the conversion layout file includes identifying information identifying the plurality of images in the combined image, and sends the at least one coupled-image file and the conversion layout file to the client computer.

### BACKGROUND

The present technology relates to an information processing apparatus capable of communicating with other information processing apparatuses, and to an information processing method, an information processing system, and a program in the information processing apparatus.

In recent years, more client terminals execute applications through a web browser via a network, and more varieties of client terminals have been used. In accordance therewith, it has become more popular for servers to hold contents to be displayed on a display of the client terminal in forms of component data (models) and display-method data (views). For example, the server sends a web page to the client terminal in HTML (HyperText Markup Language) and CSS (Cascading Style Sheets) for displaying the web page.

This method has a problem that, when the client terminal downloads many images, view creation in the client terminal involves time and effort owing to more complexity of model architecture. In particular, in terms of processing speed, display may be slow when the client terminal is a mobile terminal.

Further, in some cases, as for web pages on which many predetermined images are to be displayed (for example, a top page which a user frequently accesses), the server couples a plurality of images to each other in advance and stores the images. In these cases, when a request is issued from a client terminal, the server exchanges only the one coupled image and a layout description file (for example, a CSS file) with the client terminal on the network. In the client terminal, at the time of rendering a web page, the one image is laid out as if a plurality of images existed. Such a technique is generally called CSS Sprites (for example, refer to Japanese Patent Application Laid-open No. 2010-277501). This technique is advantageous in that the number of requests sent from the client terminal becomes smaller and consequently a speed until completion of rendering becomes higher.

### SUMMARY

However, when the above-mentioned CSS Sprites technique is employed, determination as to which of the images are coupled to each other and held is made by the server. Thus, when a user of a client terminal issues a request for an image, a coupled image obtained by coupling the requested image and other images to each other is sent to the client terminal. As a result, images that are not wanted by the user to be displayed are also sent. In other words, unnecessary exchanges of data are more frequently performed, and display efficiency is also deteriorated.

In view of the circumstances as described above, there is a need for providing an information processing apparatus, an information processing system, an information processing method, and a program which are capable of optimizing a response to requests for images from a client terminal and efficiently displaying the images on a browser of the client terminal.

One exemplary embodiment described herein is directed to an apparatus comprising at least one storage device configured to store a plurality of processor-executable instructions and at least one processing unit communicatively coupled to the at least one storage device, wherein execution of the processor-executable instructions by the at least one processing unit causes the processing unit to receive from a client computer one or more requests for image data; generate at least one coupled-image file and a conversion layout file based, at least in part, on information in the one or more requests for image data, wherein the at least one coupled-image file includes image data for a plurality of images to form a combined image and the conversion layout file includes identifying information identifying the plurality of images in the combined image; and send the at least one coupled-image file and the conversion layout file to the client computer.

Another exemplary embodiment described herein is directed to a method of processing one or more requests for image data. The method comprises receiving from a client computer one or more requests for image data; generating at least one coupled-image file and a conversion layout file based, at least in part, on information in the one or more requests for image data, wherein the at least one coupled-image file includes image data for a plurality of images to form a combined image and the conversion layout file includes identifying information identifying the plurality of images in the combined image; and sending the at least one coupled-image file and the conversion layout file to the client computer.

A further exemplary embodiment described herein is directed to a computer-readable medium encoded with a plurality of instructions that, when executed by at least one processing unit, perform a method. The method comprises receiving from a client computer one or more requests for image data; generating at least one coupled-image file and a conversion layout file based, at least in part, on information in the one or more requests for image data, wherein the at least one coupled-image file includes image data for a plurality of images to form a combined image and the conversion layout file includes identifying information identifying the plurality of images in the combined image; and sending the at least one coupled-image file and the conversion layout file to the client computer.

Another exemplary embodiment described herein is directed to a system comprising at least one client computer configured to send one or more requests for image data and at least one server computer communicatively coupled to the at least one client computer via at least one network. The at least one server computer comprises: at least one storage device configured to store a plurality of processor-executable instructions; and a processing unit communicatively coupled to the at least one storage device. Execution of the processor-executable instructions by the processing unit causes the processing unit to receive from the at least one client computer one or more requests for image data; generate at least one coupled-image file and a conversion layout file based, at least in part, on information in the one or more requests for image data, wherein the at least one coupled-image file includes image data for a plurality of images to form a combined image and the conversion layout file includes identifying information identifying the plurality of images in the combined image; and send the at least one coupled-image file and the conversion layout file to the at least one client computer.

Another exemplary embodiment described herein is directed to an apparatus comprising at least one storage device configured to store a plurality of processor-executable instructions and a processing unit communicatively coupled to the at least one storage device. Execution of the processor-executable instructions by the processing unit causes the processing unit to send one or more requests for image data to at least one server computer; receive, in response to sending the one or more requests, at least one coupled-image file and a conversion layout file, wherein the at least one coupled-image file includes a combined image including image data for a plurality of images, and wherein the conversion layout file includes identifying information identifying the plurality of images in the combined image; and render based, at least in part, on the identifying information in the conversion layout file, at least one of the plurality of images from the combined image on a display.

Another exemplary embodiment described herein is directed to a method of requesting image data. The method comprises sending one or more requests for image data to at least one server computer; receiving, in response to sending the one or more requests, at least one coupled-image file and a conversion layout file, wherein the at least one coupled-image file includes a combined image including image data for a plurality of images, and wherein the conversion layout file includes identifying information identifying the plurality of images in the combined image; and rendering based, at least in part, on the identifying information in the conversion layout file, at least one of the plurality of images from the combined image on a display.

Another exemplary embodiment described herein is directed to a computer-readable medium encoded with a plurality of instructions that, when executed by at least one processing unit, perform a method. The method comprises sending one or more requests for image data to at least one server computer; receiving, in response to sending the one or more requests, at least one coupled-image file and a conversion layout file, wherein the at least one coupled-image file includes a combined image including image data for a plurality of images, and wherein the conversion layout file includes identifying information identifying the plurality of images in the combined image; and rendering based, at least in part, on the identifying information in the conversion layout file, at least one of the plurality of images from the combined image on a display.

These and other objects, features and advantages of the present disclosure will become more apparent in light of the following detailed description of best mode embodiments thereof, as illustrated in the accompanying drawings.

### BRIEF DESCRIPTION OF DRAWINGS

FIG. 1 illustrates a configuration of an image-display system according to an embodiment of the present technology;

FIG. 2 illustrates a hardware configuration of a server in the image-display system;

FIG. 3 illustrates a hardware configuration of a PC in the image-display system;

FIG. 4 is a function block diagram of software modules of the server;

FIG. 5 shows a configuration of a coupled-image-file-information database of the server;

FIG. 6 is a sequence diagram showing a summary of a flow of requests and responses exchanged with each other between the server and the PC;

FIGS. 7(A) and 7(B) schematically show image acquisition requests to be sent from the PC and responses thereto from the server;

FIG. 8 illustrates a display example (layout example) of a plurality of images corresponding to objects of the image acquisition requests in a display unit of the PC;

FIG. 9 illustrates an example of a coupled-image file obtained by coupling the plurality of images to each other;

FIG. 10 illustrates an example of the image acquisition request;

FIG. 11 is a flowchart showing a flow in which the server receives the image acquisition requests and sends the responses to the requests;

FIG. 12 is a list of position coordinates and sizes of the image files of the coupled-image file in a case where the image files are coupled to each other in a single vertical row;

FIG. 13 is a list of position coordinates and sizes of the image files of the coupled-image file illustrated in FIG. 9 in a case where the image files are laid out in a single horizontal row as illustrated in FIG. 8;

FIG. 14 shows in more detail the responses illustrated in FIG. 7(B) from the server;

FIG. 15 schematically shows image files of groups illustrated in FIG. 14 in a tree structure;

FIG. 16 is a list of details of a conversion layout file to be sent from the server; and

FIG. 17 is a flowchart showing a flow in which the PC sends the image acquisition requests, receives the responses from the server, and displays the image files.

### DETAILED DESCRIPTION OF EMBODIMENT

Hereinafter, an embodiment of the present technology will be described with reference to the drawings.

(Summary of System)

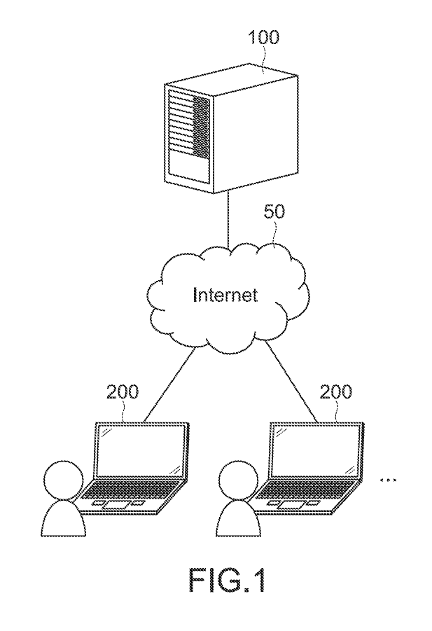

FIG. 1 illustrates a configuration of an image-display system according to an embodiment of the present technology.

As illustrated in FIG. 1, this system includes a server 100 and a client PC 200 (hereinafter, simply referred to as PC 200). The PC 200 may include a plurality of PCs 200.

The PC 200 issues a request for a web page including a plurality of image files to the server 100 via a web browser (hereinafter, simply referred to as browser). In response to the request, the server 100 sends the web page and the image files to the PC 200 together with layout data of the image files.

In this embodiment, the server 100 is capable of creating a coupled-image file by coupling the plurality of image files to each other in response to the request from the PC 200, and returning the coupled-image file to the PC 200 as a response. A creation process for the coupled-image file will be described later.

(Hardware Configuration of Server)

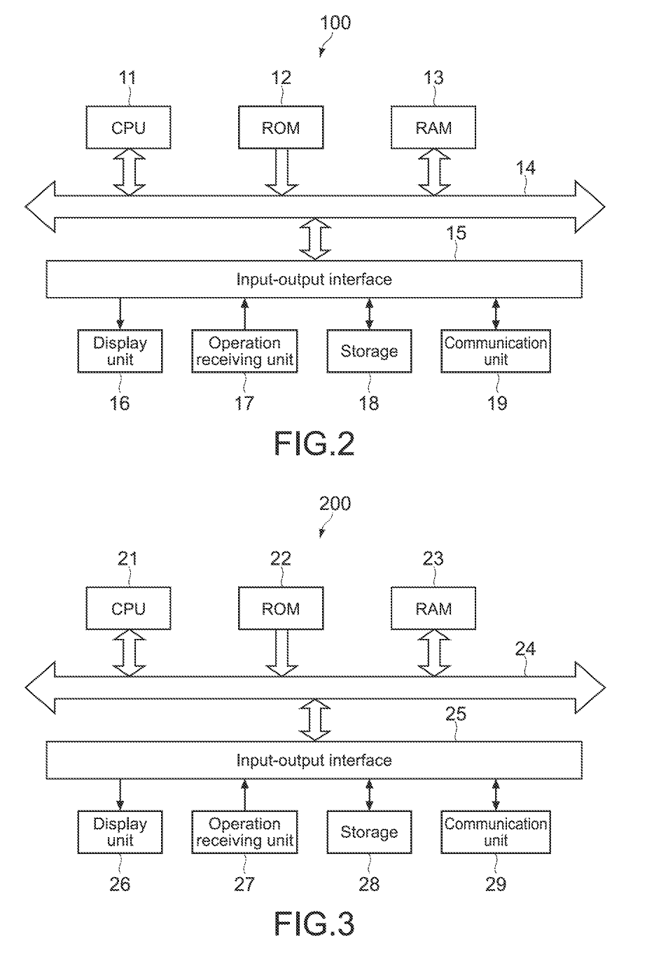

FIG. 2 illustrates a hardware configuration of the server 100. As illustrated in FIG. 2, the server 100 includes a CPU (Central Processing Unit) 11, a ROM (Read

Only Memory) 12, and a RAM (Random Access Memory) 13, an input-output interface 15, and a bus 14 for connecting those components to each other.

The CPU 11 appropriately accesses the RAM 13 and the like when necessary, and controls the blocks of the server 100 as a whole while performing various arithmetic processes. The ROM 12 is a non-volatile memory fixedly storing an OS to be executed by the CPU 11, and firmware including programs and various parameters. The RAM 13 is used, for example, as a working area for the CPU 11, and temporarily stores the OS, various running applications, and various types of data under processing.

A display unit 16, an operation receiving unit 17, a storage 18, a communication unit 19, and the like are connected to the input-output interface 15.

The display unit 16 includes a display device using an LCD, an GELD, a CRT (Cathode Ray Tube), and the like.

The operation receiving unit 17 includes a pointing device such as a mouse, a keyboard, a touch panel, and other input apparatuses. When a touch panel is used as the operation receiving unit 17, the touch panel may be integrated with the display unit 16.

The storage 18 includes an HDD (Hard Disk Drive), and a non-volatile memory such as a flash memory (SSD; Solid State Drive) and other solid memories. The storage 18 stores the OS, the various applications, and the various types of data. In particular, in this embodiment, the storage 18 stores web-page files to be displayed on the browser of the PC 200 (hereinafter, simply referred to as page files) and the plurality of image files to be laid out on each of the page files.

The communication unit 19 includes, for example, an NIC for establishing a wired connection to the Internet 50 or a LAN, and performs a communication process (receives requests and sends responses) between the server 100 and the PC 200.

(Hardware Configuration of PC)

FIG. 3 illustrates a hardware configuration of the PC 200. As illustrated in FIG. 3, the hardware configuration of the PC 200 is basically the same as the hardware configuration of the server 100. Specifically, the PC 200 includes a CPU 21, a ROM 22, a RAM 23, an input-output interface 25, a bus 24 for connecting those components to each other, a display unit 26, an operation receiving unit 27, a storage 28, and a communication unit 29.

The display unit 26 may be incorporated in the PC 200, or may be externally connected to the PC 200. When the display unit 26 is externally connected to the PC 200, video signals are output to the display unit 26 via a video output unit (a video output terminal and the like) of the PC 200.

The storage 28 stores a browser for receiving web-page files, image files, and a layout file from the server 100 and rendering a page by laying out the image files on the web page.

In this embodiment, the browser of the PC 200 has a general web-page-display function, and also has, for example, a function of an application for listing many images arrayed in time series. In this context, this function may be installed to the PC 200 in a form of software separate from the browser. More specifically, this application may include an application for displaying, in time series, a plurality of images which have been periodically photographed by surveillance cameras installed at predetermined positions. Further, this application may include an application for displaying, in time series, a plurality of images photographed by a user in a predetermined time period (for example, one day on a trip).

(Software Configuration of Server)

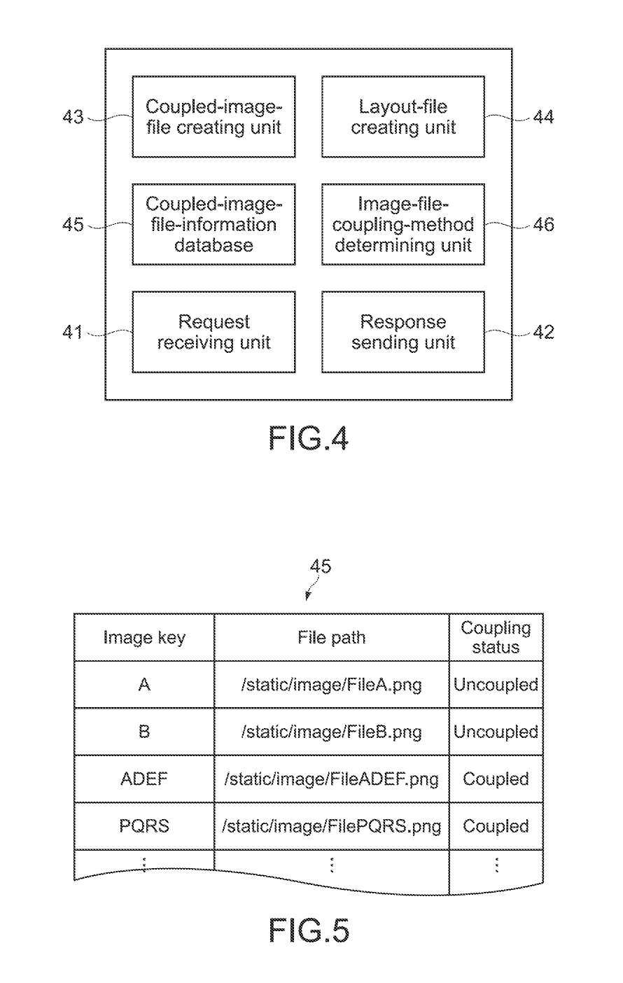

FIG. 4 is a function block diagram of software modules of the server 100. Each of the software modules is a module mainly for responding to a request from the PC 200, and the server 100 includes other software modules.

As shown in FIG. 4, as the software modules, the server 100 includes a request receiving unit 41, a response sending unit 42, a coupled-image-file creating unit 43, a layout-file creating unit 44, a coupled-image-file-information database 45, and an image-file-coupling-method determining unit 46.

The request receiving unit 41 receives a request from the PC 200, and transmits information of the request to the image-file-coupling-method determining unit 46.

The image-file-coupling-method determining unit 46 analyzes the received request, and determines image files to be coupled to each other and a method of coupling the image files.

The coupled-image-file creating unit 43 creates a coupled-image file by coupling a plurality of image files to each other according to the coupling method determined by the image-file-coupling-method determining unit 46.

The layout-file creating unit 44 creates a layout file based on which the PC 200 lays out the image files of the coupled-image file created by the coupled-image-file creating unit 43 onto a page file.

The coupled-image-file-information database 45 stores the coupled-image file thus created.

The response sending unit 42 sends the coupled-image file and the layout file thus created to the PC 200 as responses.

(Configuration of Coupled-Image-File-Information Database)

FIG. 5 shows a configuration of the coupled-image-file-information database 45.

As shown in FIG. 5, the coupled-image-file-information database 45 contains data items of the following: image keys for identifying image files; file paths indicating paths of the image files; and coupling statuses indicating whether or not the image files are coupled-image files.

The coupled-image-file-information database 45 stores uncoupled image files together with coupled-image files. For example, of the four images shown in FIG. 5, the upper two image files are uncoupled files, and the lower two image files are coupled-image files.

(Operation of System)

Next, description is made of operations of the server 100 and the PC 200 in the image-display system configured as described above. These operations are performed in cooperation with other hardware and software (browser of the PC 200) under control by the CPU 11 of the server 100 and the CPU 21 of the PC 200.

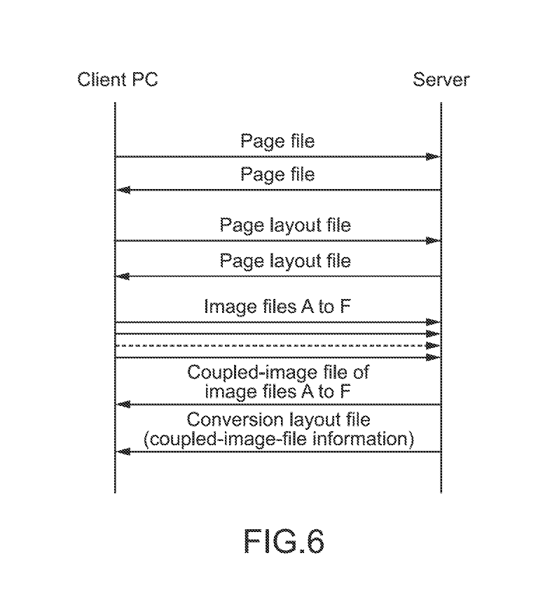

FIG. 6 is a sequence diagram showing a summary of a flow of requests (HTTP requests) and responses (HTTP responses) exchanged with each other between the server 100 and the PC 200 in this embodiment.

As shown in FIG. 6, the PC 200 first issues a request for a page file as a whole (index.html) to the server 100, and the server 100 sends the page file (HTML file) as a response to the request. The request contains a URI of the page file, and the page file contains respective URIs of a plurality of image files to be laid out on the page file.

Subsequently, the PC 200 issues a request for a layout file indicating a whole layout on the page file to the server 100, and the server 100 sends a whole-layout file to the PC 200 as a response to the request.

Subsequently, based on the URIs contained in the page file, the PC 200 sends requests for the plurality of image files to be laid out on the page file (image acquisition requests) to the server 100. These requests are sent as many as the image files. In response to the plurality of requests, the server 100 couples the plurality of image files corresponding to those requests to each other, and sends the coupled-image file thus obtained to the PC 200 as a response.

Further, the server 100 creates a layout file (conversion layout file) indicating how to lay out the image files of the coupled-image file on the page file, and also sends the conversion layout file to the PC 200 as a response to the image acquisition requests.

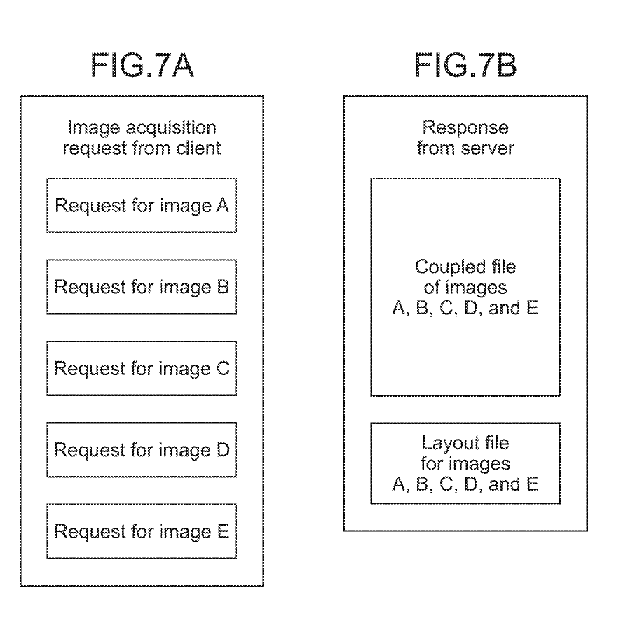

FIGS. 7(A) and 7(B) schematically show the image acquisition requests and responses thereto.

As illustrated in FIGS. 7(A) and 7(B), although the requests from the PC 200 exist as many as the image files, the server 100 sends only one coupled-image file and only one conversion layout file as responses.

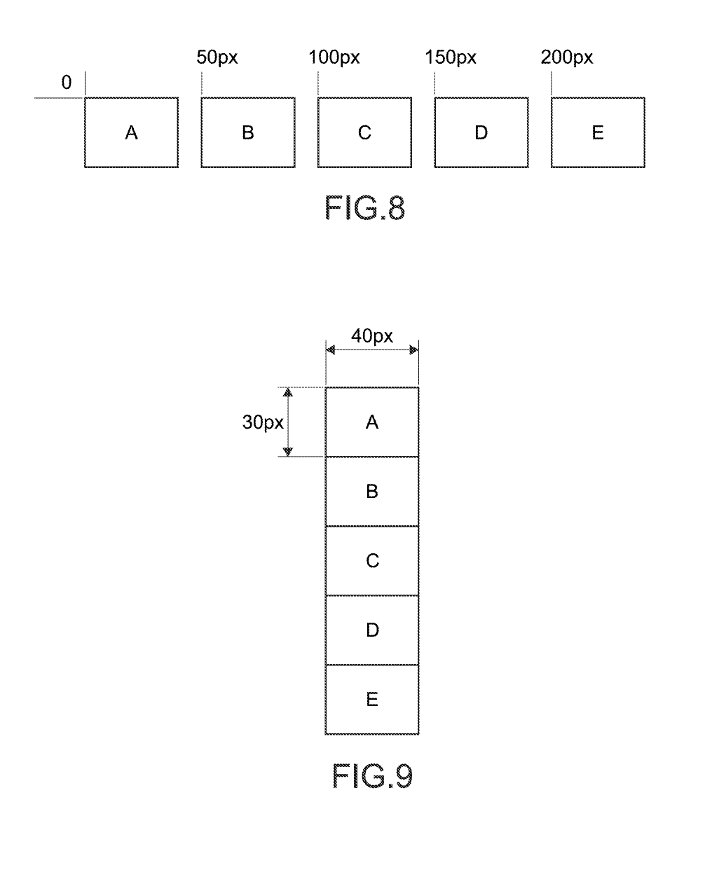

FIG. 8 illustrates a display example (layout example) of the plurality of images corresponding to objects of the image acquisition requests in the display unit 26 of the PC 200. Further, FIG. 9 illustrates an example of the coupled-image file obtained by coupling the plurality of images to each other.

As illustrated in FIG. 9, the coupled-image file is obtained by coupling the plurality of images (images A to E), for example, in a single vertical row. However, as illustrated in FIG. 8, the PC 200 extracts the images A to E of the coupled-image file and lay out those images based on the conversion layout file, for example, separately at a predetermined interval in a single horizontal row on the display unit 26.

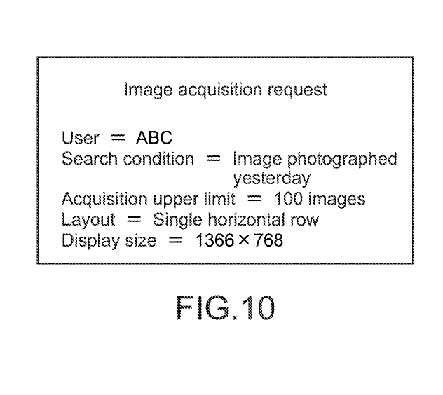

FIG. 10 illustrates an example of the image acquisition requests. As illustrated in FIG. 10, each of the image acquisition requests contains items of a user name, a search condition, an acquisition upper limit, a layout, and a display size.

The search condition includes a filtering condition with respect to image files stored (for example, for each user) in the server 100, such as “image photographed yesterday,” and specifies a creation date, a creation period, and the like of each of the images. However, the search condition is not limited thereto and may include a predetermined keyword.

The upper limit indicates an upper limit of the number of images to be acquired, in other words, an upper limit of the number of (apparent) images to be displayed on the display unit 26.

Various layouts such as a single horizontal row, a single vertical row, and an alignment of horizontal X images by vertical Y images, may be employed as the layout.

The display size indicates a size of the display unit 26 of the PC 200. Although detailed description will be made later, this information is used when the server 100 determines the number of images belonging to groups each of which contains a predetermined number of images and in each of which the coupled-image file is to be created.

(Operation of Server)

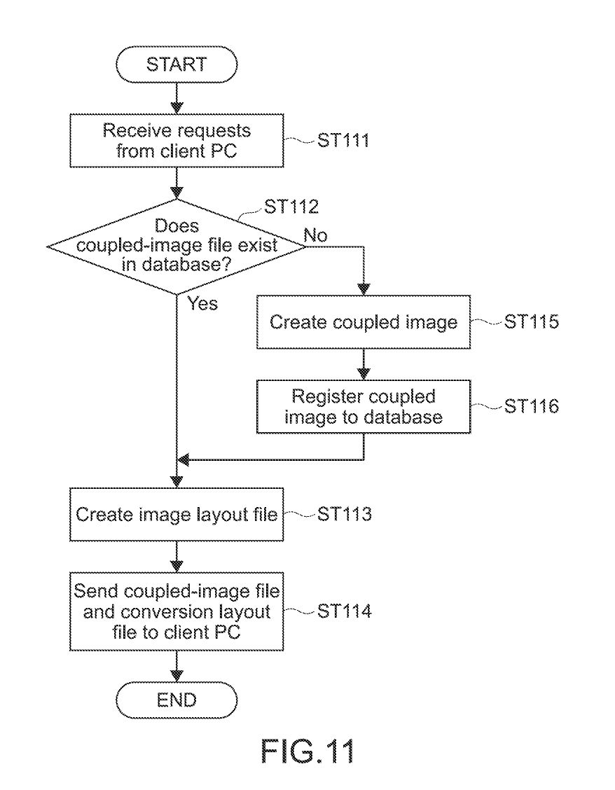

FIG. 11 is a flowchart showing a summary of a flow in which the server 100 receives the image acquisition requests and sends the responses to the requests. This flowchart shows a flow of the step of receiving the image acquisition requests from the PC 200 and the subsequent steps of a series of exchanges shown above in FIG. 6.

As shown in FIG. 11, the CPU 11 of the server 100 first receives image acquisition requests from the PC 200 (Step ST111).

Subsequently, the CPU 11 analyzes the image acquisition requests, and judges whether or not a coupled-image file of image files contained in the image acquisition requests exists in the coupled-image-file-information database 45 (Step ST112).

In a case of having judged that the coupled-image file exists (Yes), based on layout information contained in the image acquisition requests, the CPU 11 creates a conversion layout file based on which the plurality of image files corresponding to acquisition objects are displayed in the PC 200 (Step ST113).

In a case of having judged that the coupled-image file does not exist (No), from the coupled-image-file-information database 45, the CPU 11 reads out the plurality of image files corresponding to objects of the image acquisition requests, and creates a coupled-image file by coupling those image files to each other (Step ST115). Then, the CPU 11 registers (an image key and a file path of) the coupled-image file thus created to the coupled-image-file-information database 45 (Step ST116).

Subsequently, based on the layout information contained in the image acquisition requests, the CPU 11 creates a conversion layout file based on which the image files of the coupled-image file are to be laid out on the page file in the display unit 26 of the PC 200 (Step ST113).

Then, the CPU 11 sends the coupled-image file and the conversion layout file to the PC 200 as responses to the image acquisition requests (Step ST114).

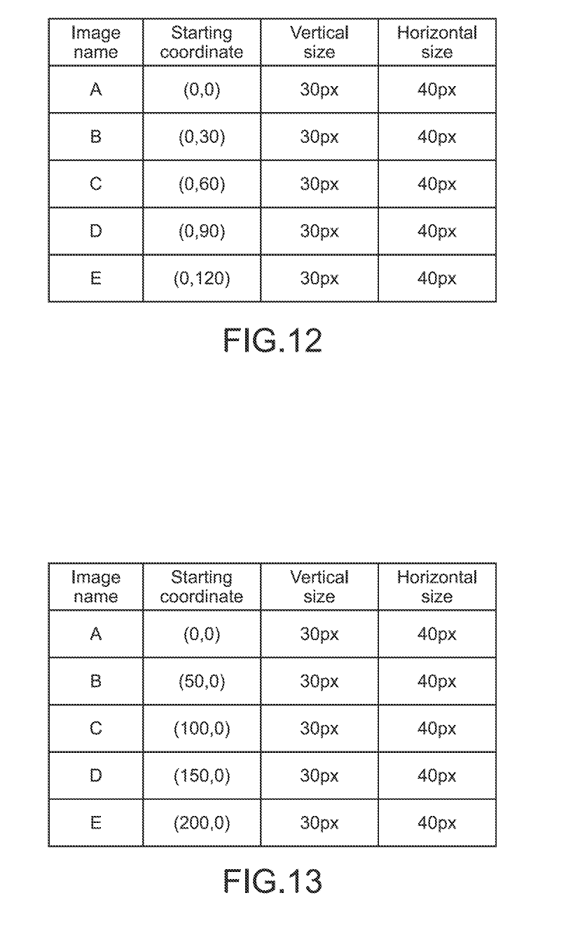

FIG. 12 is a list of coordinates and sizes of the image files of the coupled-image file, the image files being coupled to each other in a single vertical row as illustrated in FIG. 9. As shown in FIG. 9, the image files are coupled to each other in a vertical direction. Thus, starting coordinates of the image files A to E shift in a Y-axis direction. Those coordinates are relative coordinates with respect to an upper-left end of the coupled-image file.

FIG. 13 is a list of coordinates and sizes of the image files of the coupled-image file illustrated in FIG. 9 in a case where the image files are laid out in a single horizontal row as illustrated in FIG. 8. As shown in FIG. 13, the starting coordinates of the image files A to E shift in an X-axis direction so that the image files are displayed in a single horizontal row.

The CPU 11 creates the conversion layout file with use of the coordinates and the sizes shown in FIGS. 12 and 13. Detailed description of a process of creating the conversion layout file is made below.

As described above, the server 100 is capable of coupling all the image files into one image in response to the image acquisition requests from the PC 200. However, when the number of image files coupled into one image and sent to the PC 200 is excessively large, image sizes of the image files become inevitably larger in accordance therewith, which may lead to a risk of deteriorating efficiency in displaying the image files in the PC 200. As a countermeasure, in this embodiment, the server 100 is also capable of dividing the plurality of object image files into a plurality of groups each of which contains a predetermined number of images, and respectively creating a plurality of coupled-image files for the groups. Units in which the image files are divided into groups are appropriately determined in accordance with the display size, processability, a network bandwidth, types of applications to be executed by the PC 200, and the like. Of those, in this embodiment, the number of image files contained in the groups is changed in accordance with the display size of the PC 200. The display size of the PC 200 is contained in the image acquisition requests as described above, and the server 100 determines the number of image files in each of the groups based on the display size.

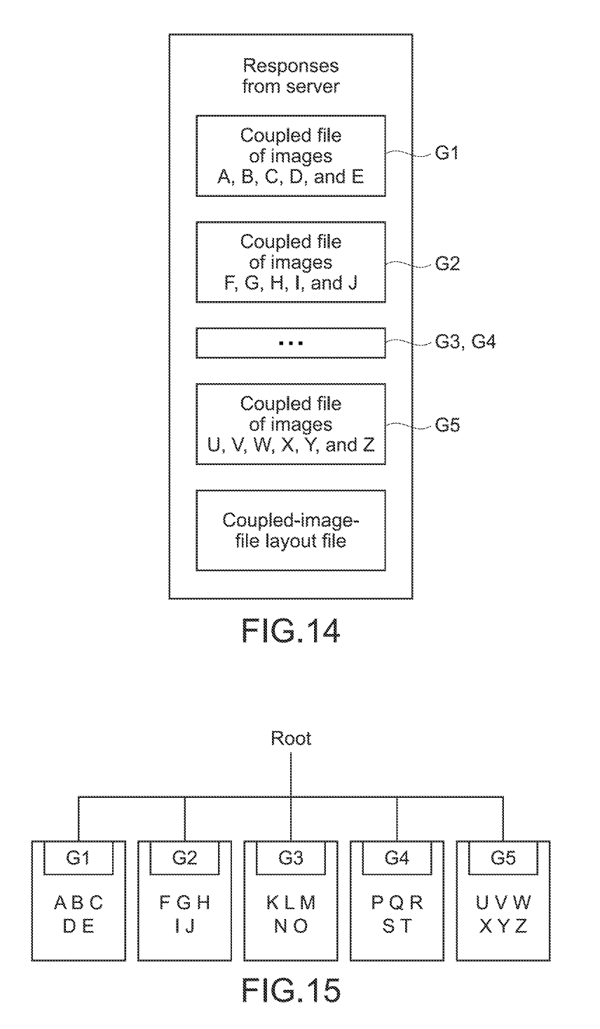

FIG. 14 shows in more detail the responses illustrated above in FIG. 7(B) from the server. As shown in FIG. 14, the image files A to Z are divided into the five groups G1 to G5, and respective coupled-image files of the groups are created and returned as responses. The numbers of image files in the groups (the numbers of image files coupled to each other so that the coupled-image files are obtained) are set to be as equal to each other as possible. In this example, the remainder of division of twenty-six, which is the number of image files A to Z, by five is one, and hence each of the groups G1 to G4 contains five image files and only the group G5 contains six image files.

The number of image files contained in each of the groups is set to be, for example, twice or three times as large as the number of image files that can be displayed on the display of the display unit 26 of the PC 200. However, this should not be construed restrictively.

As described above, even when the plurality of coupled-image files are created and sent as responses, only one conversion layout file is created.

FIG. 15 schematically shows the image files of the groups in a tree structure. As shown in FIG. 15, a plurality of image files are layered into a plurality of groups, and the image files belong to the groups.

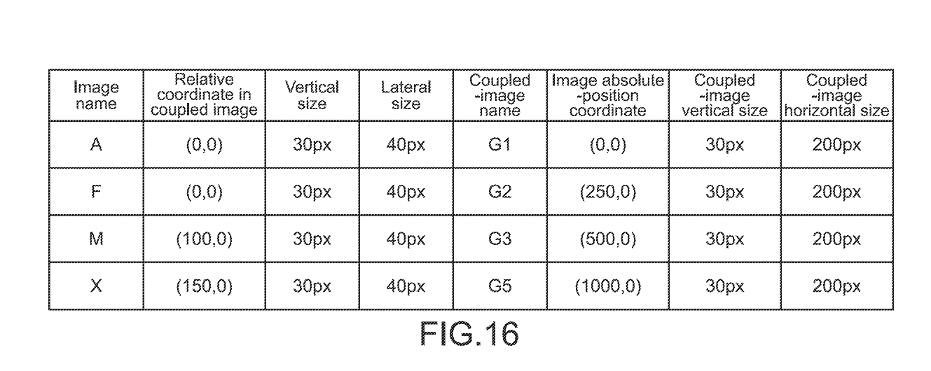

FIG. 16 is a list of details of the conversion layout file. As shown in FIG. 16, the conversion layout file contains items of an image-file name, a relative coordinate in a coupled image, vertical and horizontal sizes, a coupled-image file name, an image absolute coordinate, and vertical and horizontal sizes of the coupled image with regard to each of the image files.

As shown above in FIG. 12, the relative coordinate in a coupled image indicates relative coordinates of each of the image files coupled to each other with respect to the upper-left end of the coupled-image file. The coupled-image file name indicates a name of the coupled-image file obtained by coupling the image files to each other. As shown above in FIG. 13, the image absolute coordinate indicates absolute coordinates of each of the image files of the coupled-image file, reflecting the layout information contained in the image acquisition requests. The vertical and horizontal sizes of a coupled image indicate vertical and horizontal sizes of the coupled-image file as a whole obtained by coupling the image files to each other.

(Operation of PC)

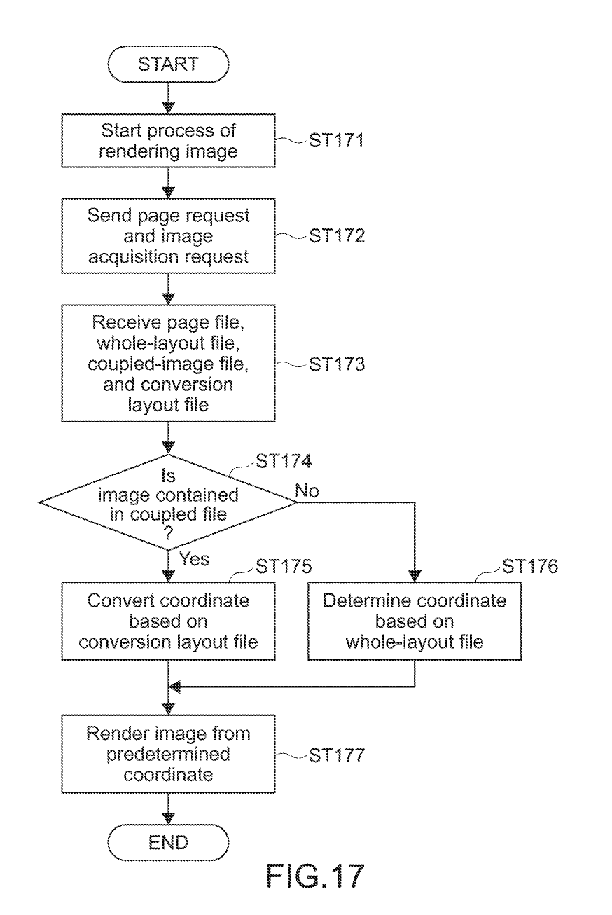

Based on the conversion layout file shown above in FIG. 16, the PC 200 lays out and renders the image files on the page file. FIG. 17 is a flowchart showing a flow in which the PC 200 sends the image acquisition requests, receives the responses from the server 100, and displays the image files.

The flowchart shows a process flow in a case where the PC 200 renders one of the images of the coupled-image file. Further, hereinabove, although description is made on a premise that all image files are contained in a coupled-image file, in this flowchart, it is also assumed that an image file alone exists without being contained in a coupled-image file. Examples of the case where image files are not contained in a coupled-image file include a case where image files as coupling objects have not yet been created (for example, state in which photographing by a user has been waited).

As shown in FIG. 17, in a case of having judged that it is necessary to render a specific image file, the CPU 21 of the PC 200 first starts a process of rendering the image file (Step ST171), and then sends the page request and an image acquisition request to the server 100 (Step ST172).

Subsequently, the CPU 21 receives a page file, a whole-layout file, a coupled-image file (or uncoupled image file), and a conversion layout file from the server 100 as responses to the requests (Step ST173).

Subsequently, the CPU 21 refers to the conversion layout file, and judges whether or not the image file as a rendering object is contained in the coupled-image file (Step ST174).

When the image file is contained in the coupled-image file (Yes), based on the conversion layout file, the CPU 21 converts relative coordinates of the image file in the coupled-image file into the image absolute-position coordinates (Step ST175).

When the image file is not contained in the coupled-image file (No), based on the whole-layout file, the CPU 21 determines coordinates of the image file (Step ST176).

Then, the CPU 21 renders the image file from the coordinates obtained by conversion in Step ST175 or from the coordinates determined in Step ST176 (Step ST177).

For example, when the image M in FIG. 16 is rendered, the CPU 21 judges that the image M belongs to the coupled-image file G3, cuts out data of vertical thirty pixels by horizontal forty pixels from coordinates (100, 0) in the coupled-image file G3, and renders the cut-out data on converted coordinates (500, 0) in the web page.

The CPU 21 repeats the process described above with respect to all of the image files required to be rendered.

(Conclusion)

As described hereinabove, according to this embodiment, in response to requests from the PC 200, the server 100 couples a plurality of image files to each other and returns one coupled-image file. In this way, the response to the requests can be optimized, and hence the plurality of image files can be efficiently displayed on a browser of the PC 200.

(Modifications)

The present technology is not limited to the embodiment described above, and various changes can be made thereto without departing from the gist of the present technology.

In the above-mentioned embodiment, an example in which the client PC 200 acquires image files from the server 100 is described. In this context, it is unnecessary to perform the function of the client PC 200 and the function of the server 100 in respective apparatuses physically separated from each other. In other words, one apparatus may logically separately have both the function of the client PC 200 and the function of the server 100.

For example, the function of the client PC 200 may be provided as a browser, and the function of the server 100 may be provided as a daemon. The operation in this apparatus is the same as the operation in the image-display system described above except that a signal process between the browser and the daemon is performed in the apparatus instead of the communication process between the server 100 and the PC 200 via a network.

In the above-mentioned embodiment, although an example in which image files are displayed by an application for listing many images arrayed in time series is described, the present technology may be carried out by other applications. For example, the present technology is also applicable to an image-search application.

Specifically, when a user of the PC 200 enters a predetermined keyword via a browser and instructs an image search, the PC 200 recognizes the keyword as a search condition and sends an image acquisition request similar to those described above to the server 100. The server 100 having received the image acquisition request couples image files matching the keyword to each other as in the above-mentioned embodiment, and send a coupled-image file and a conversion layout file to the PC 200 as responses. After having received the responses, the PC 200 cuts out image files from the coupled-image file as in the flow in the above-mentioned embodiment, and displays the image files as image-search results.

In this case, the server 100 may create a coupled-image file by coupling in advance image files matching a specific keyword to each other. Only one coupled-image file may be created, or as in the above-mentioned embodiment, a plurality of coupled-image files may be respectively created for a plurality of groups, for example, in accordance with the display size of the PC 200.

Further, in a case where the image files matching the keyword contained in the image acquisition requests from the PC 200 have already existed as a coupled-image file, the server 100 sends the coupled-image file as a response without newly coupling the image files to each other. Further, when the request from the PC 200 is an OR search with a plurality of keywords, the server 100 judges whether or not the coupled-image file exists with reference to each of the keywords. The coupled-image file may be sent after being additionally coupled to a plurality of coupled-image files having been confirmed to already exist as a result of reference to each of the keywords or additionally coupled to a plurality of newly created coupled-image files. Alternatively, a plurality of coupled-image files may be sent as they are.

In the above-mentioned embodiment, an example in which a client in the present technology is the PC 200 is described. However, the client in the present technology may include any other information processing apparatuses such as a mobile phone, a smart phone, an audio player, a television apparatus, a video gaming apparatus, a car-navigation apparatus, and a recording and reproducing apparatus.

Additionally, the present technology may also be configured as below.

(1)

An apparatus, comprising:

at least one storage device configured to store a plurality of processor-executable instructions; and

at least one processing unit communicatively coupled to the at least one storage device, wherein execution of the processor-executable instructions by the at least one processing unit causes the processing unit to:

receive from a client computer one or more requests for image data;

generate at least one coupled-image file and a conversion layout file based, at least in part, on information in the one or more requests for image data, wherein the at least one coupled-image file includes image data for a plurality of images to form a combined image and the conversion layout file includes identifying information identifying the plurality of images in the combined image; and

send the at least one coupled-image file and the conversion layout file to the client computer.

(2)

The apparatus according to (1), wherein the identifying information in the conversion layout file comprises location information identifying locations of the plurality of images in the combined image.

(3)

The apparatus according to any one of (1) or (2), wherein the conversion layout file includes at least one size dimension of at least one of the plurality of images in the combined image.

(4)

The apparatus according to any one of (1) to (3), wherein generating at least one combined-image file comprises generating a plurality of combined-image files, wherein each of the plurality of combined-image files includes at least one image corresponding to the image data specified in the one or more requests.

(5)

The apparatus according to (4), wherein the identifying information in the conversion layout file associates images corresponding to the image data specified in the one or more requests with one of the plurality of combined-image files.

(6)

The apparatus according to any one of (4) or (5), wherein the plurality of combined-image files are generated based, at least in part, on a file size for one or more image files for the image data in the one or more requests, a network bandwidth, and/or types of applications to be executed by the client computer.

(7)

The apparatus according to any one of (4) to (6), wherein a number of image files included in each of the plurality of combined-image files is determined based, at least in part, on a display size of the client computer.

(8)

The apparatus according to any one of (1) to (7), wherein receiving one or more requests for image data comprises receiving a plurality of requests for image data, and wherein generating at least one coupled-image file comprises generating a single coupled-image file including all image data specified in the plurality of requests.

(9)

The apparatus according to any one of (1) to (8), wherein the at least one storage device is further configured to store a coupled-image file-information database, wherein the coupled-image file-information database is configured to store uncoupled image files and coupled-image files.

(10)

The apparatus according to (9), wherein generating the at least one coupled-image file comprises:

determining whether the coupled-image file-information database includes a coupled-image file including the image data specified in the one or more requests; and

retrieving the coupled-image file from the coupled-image file-information database in response to determining that the coupled-image file-information database includes the coupled-image file including the image data specified in the one or more requests.

The apparatus according to any of (9) or (10), wherein execution of the processor-executable instructions by the processing unit further causes the at least one processing unit to:

register the generated at least one coupled-image file to the coupled-image file-information database.

What is claimed is:

1. An apparatus, comprising:
at least one storage device configured to store a plurality of processor-executable instructions; and
at least one processing unit communicatively coupled to the at least one storage device, wherein execution of the processor-executable instructions by the at least one processing unit causes the processing unit to:
receive from a client computer one or more requests for image data;
generate at least one coupled-image file and a conversion layout file based, at least in part, on information in the one or more requests for image data, wherein the at least one coupled-image file includes image data for a plurality of images to form a combined image and the conversion layout file includes identifying information identifying the plurality of images in the combined image; and
send the at least one coupled-image file and the conversion layout file to the client computer.

2. The apparatus of claim 1, wherein the identifying information in the conversion layout file comprises location information identifying locations of the plurality of images in the combined image.

3. The apparatus of claim 1, wherein the conversion layout file includes at least one size dimension of at least one of the plurality of images in the combined image.

4. The apparatus of claim 1, wherein generating at least one combined-image file comprises generating a plurality of combined-image files, wherein each of the plurality of combined-image files includes at least one image corresponding to the image data specified in the one or more requests.

5. The apparatus of claim 4, wherein the identifying information in the conversion layout file associates images corresponding to the image data specified in the one or more requests with one of the plurality of combined-image files.

6. The apparatus of claim 4,wherein the plurality of combined-image files are generated based, at least in part, on a file size for one or more image files for the image data in the one or more requests, a network bandwidth, and/or types of applications to be executed by the client computer.

7. The apparatus of claim 4, wherein a number of image files included in each of the plurality of combined-image files is determined based, at least in part, on a display size of the client computer.

8. The apparatus of claim 1, wherein receiving one or more requests for image data comprises receiving a plurality of requests for image data, and wherein generating at least one coupled-image file comprises generating a single coupled-image file including all image data specified in the plurality of requests.

9. The apparatus of claim 1, wherein the at least one storage device is further configured to store a coupled-image file-information database, wherein the coupled-image file-information database is configured to store uncoupled image files and coupled-image files.

10. The apparatus of claim 9, wherein generating the at least one coupled-image file comprises:
determining whether the coupled-image file-information database includes a coupled-image file including the image data specified in the one or more requests; and
retrieving the coupled-image file from the coupled- image file-information database in response to determining that the coupled-image file-information database includes the coupled-image file including the image data specified in the one or more requests.

11. The apparatus of claim 9, wherein execution of the processor-executable instructions by the processing unit further causes the at least one processing unit to:
register the generated at least one coupled-image file to the coupled-image file-information database.

12. A method of processing one or more requests for image data, the method comprising:
receiving from a client computer one or more requests for image data;
generating at least one coupled-image file and a conversion layout file based, at least in part, on information in the one or more requests for image data, wherein the at least one coupled-image file includes image data for a plurality of images to form a combined image and the conversion layout file includes identifying information identifying the plurality of images in the combined image; and
sending the at least one coupled-image file and the conversion layout file to the client computer.

13. A computer-readable medium encoded with a plurality of instructions that, when executed by at least one processing unit, perform a method comprising:
receiving from a client computer one or more requests for image data;
generating at least one coupled-image file and a conversion layout file based, at least in part, on information in the one or more requests for image data, wherein the at least one coupled-image file includes image data for a plurality of images to form a combined image and the conversion layout file includes identifying information identifying the plurality of images in the combined image;
and sending the at least one coupled-image file and the conversion layout file to the client computer.

14. A system, comprising:
at least one client computer configured to send one or more requests for image data; and
at least one server computer communicatively coupled to the at least one client computer via at least one network, wherein the at least one server computer comprises:
at least one storage device configured to store a plurality of processor-executable instructions; and
a processing unit communicatively coupled to the at least one storage device, wherein execution of the processor-executable instructions by the processing unit causes the processing unit to:
receive from the at least one client computer one or more requests for image data;
generate at least one coupled-image file and a conversion layout file based, at least in part, on information in the one or more requests for image data, wherein the at least one coupled-image file includes image data for a plurality of images to form a combined image and the conversion layout file includes identifying information identifying the plurality of images in the combined image; and
send the at least one coupled-image file and the conversion layout file to the at least one client computer.

15. An apparatus, comprising:
at least one storage device configured to store a plurality of processor-executable instructions; and
a processing unit communicatively coupled to the at least one storage device, wherein execution of the processor-executable instructions by the processing unit causes the processing unit to:
send one or more requests for image data to at least one server computer;
receive, in response to sending the one or more requests, at least one coupled-image file and a conversion layout file, wherein the at least one coupled-image file includes a combined image including image data for a plurality of images, and wherein the conversion layout file includes identifying information identifying the plurality of images in the combined image; and
render based, at least in part, on the identifying information in the conversion layout file, at least one of the plurality of images from the combined image on a display.

16. The apparatus of claim 15, further comprising an input device, wherein execution of the processor-executable instructions by the processing unit further causes the processing unit to:
generate the one or more requests for image data based, at least in part, on a keyword received via the input device.

17. The apparatus of claim 15, wherein the identifying information includes relative coordinate information for the plurality of images in the combined image,
wherein rendering at least one of the plurality of images from the combined image comprises converting the relative coordinate information into image absolute-position coordinate information and rendering the at least one of the plurality of images from the image absolute-position coordinate information.

18. The apparatus of claim 15, wherein rendering the at least one of the plurality of images on a display comprises rendering the at least one of the plurality of images on a web page.

19. A method of requesting image data, the method comprising:
sending one or more requests for image data to at least one server computer;
receiving, in response to sending the one or more requests, at least one coupled-image file and a conversion layout file, wherein the at least one coupled-image file includes a combined image including image data for a plurality of images, and wherein the conversion layout file includes identifying information identifying the plurality of images in the combined image; and
rendering based, at least in part, on the identifying information in the conversion layout file, at least one of the plurality of images from the combined image on a display.

20. A computer-readable medium encoded with a plurality of instructions that, when executed by at least one processing unit, perform a method comprising:
sending one or more requests for image data to at least one server computer;
receiving, in response to sending the one or more requests, at least one coupled-image file and a conversion layout file, wherein the at least one coupled-image file includes a combined image including image data for a plurality of images, and wherein the conversion layout file includes identifying information identifying the plurality of images in the combined image; and
rendering based, at least in part, on the identifying information in the conversion layout file, at least one of the plurality of images from the combined image on a display.
